(19) United States
(12) Patent Application Publication
(10) Pub. No.: US 2025/0350181 A1
(43) Pub. Date: Nov. 13, 2025

(54) High-Temperature Superconducting Windings for Conduction-Cooled Motors

(71) Applicant: Hinetics, Inc., Champaign, IL (US)

(72) Inventors: Thanatheepan Balachandran, Savoy, IL (US); Uijong Bong, Champaign, IL (US); Yiming Zhao, Champaign, IL (US); Kiruba S. Haran, Champaign, IL (US)

(21) Appl. No.: 19/204,116

(22) Filed: May 9, 2025

Related U.S. Application Data
(60) Provisional application No. 63/646,239, filed on May 13, 2024.

(51) Int. Cl. H02K 55/00; H02K 1/26; H02K 3/28; H02K 3/50

(52) U.S. Cl. CPC H02K 55/00; H02K 1/26; H02K 3/28; H02K 3/50

(57) ABSTRACT

High-temperature superconducting (HTS) windings are provided in winding modules that may be implemented in conduction-cooled electric motors. The motors may be high-powered motors, such as M W-scale (megawatt scale) motors. Each winding module may include an inner ring made from a thermally and electrically conductive material with a half-slit or slit that extends only partially through it to receive an anchoring end of an HTS tape that is used to wind the conductive coil of each HTS winding. A conductive plate with an insulated surface may cover the HTS winding, which may be mounted to a winding holder that attaches to the motor's rotor body. Adjacent winding modules transversely abut each other and are attached to an outer circumferential surface of the motor's rotor frame to provide a tightly packed winding arrangement on the rotor.

### CROSS REFERENCE TO RELATED APPLICATION

This application claims the benefit of U.S. provisional application 63/646,239 filed May 13, 2021 and hereby incorporated by reference.

### FIELD OF THE INVENTION

The present invention relates to electrical machines and in particular to a high-powered, such as an MW (megawatt) scale, superconducting electric motor.

### BACKGROUND OF THE INVENTION

Electric motors for aerospace applications, for example, for use in aircraft, desirably provide a high specific power, that is high power output with light weight.

Commonly owned U.S. patent application Ser. No. 17/498,294 filed Oct. 21, 2021, incorporated by reference, describes a superconducting motor with superconducting coils and spoke-supported windings.

Although implementing superconducting coils to improve an electric motor's power-to-weight ratio would be desirable, doing so presents numerous challenges. As one example, liquid cryogenic cooling of motors to establish superconductivity requires complex plumbing and other supporting systems, including bulky coolers and other accessories.

Materials such as HTS (high-temperature superconducting) materials can establish superconductivity at higher temperatures and correspondingly avoid many challenges associated with superconductivity through liquid cryogenic cooling. However, implementing HTS materials, such as HTS tape presents other challenges, especially in high-powered applications that require a large number of turns in their windings. Implementing HTS tapes into winding with a large number of turns can lead to instances of, for example, tension buildup within and interweaving of inner turns, excessive Lorentz forces leading to delamination, buckling, and compromised thermal conduction. Any of these conditions may ultimately degrade motor performance. Performance degradation of such HTS windings may reduce thermal stability and cause the windings or localized regions to “quench” or fall out of their superconductive state.

Although motor superconductivity using HTS windings has been performed, commercial implementation and mass-producibility of high-powered, such as M W scale, superconducting electric motors remains difficult.

### SUMMARY OF THE INVENTION

The present invention provides a high-temperature superconducting electric motor design with enhanced mechanical, electrical and thermal stability that avoids quenching. HTS windings are provided in winding modules that may be implemented in conduction-cooled electric motors, including high-powered motors, such as M W-scale (megawatt scale) motors. The HTS windings avoid quench and reduce issues related to, e.g., the windings' tension buildup, Lorentz forces, inner turn tangling, and termination resistance through mechanically interlocking various features of the windings to provide enhanced structural integrity and electrical and thermal conductivity.

It is thus a feature of at least one embodiment to implement a straight-forward design with mass-manufacturable and uniform HTS winding to enhance reliability and performance of superconducting field windings in high-power applications.

Specifically, the present invention provides in one embodiment motor windings that include lengths of conductors made from an HTS material, such as an HTS tape. The HTS tape may be wound with a sufficient number of turns to correspond to M W-scale power, with the winding's spiraled layers snugly nested against each other to maintain highly efficient electromagnetic and thermal performance within each winding.

It is thus a feature of at least one embodiment of the invention to provide HTS windings with consistently anchored conductor ends and coil-wrap uniformity that ensure quench-free operation of the HTS windings in conduction-cooled MW-scale motors.

Specifically, the present invention provides in one embodiment a winding module with an inner ring made from a thermally and electrically conductive material, such as copper. The inner ring may include a half-slit or partial slit that extends into its outer perimetral edge while the ring's inner perimeter is continuous or unbroken by the slit. The slit may at least partially define an anchor joint that receives and connects an end of the HTS winding's conductor material, such as HTS tape, to the inner ring. The inner ring's outer perimeter edge or wall provides a backer substrate against which the HTS tape is wound.

It is thus a feature of at least one embodiment to provide an HTS winding with components that facilitate form-winding to create coils of HTS material that can be mass-produced and commercially implemented.

The inner ring's partial slit may be arranged at a shallow or acute angle with respect to the inner ring's outer perimeter. The width of the inner ring's peripheral wall may vary about its perimeter and the partial slit may extend into a widened segment of the peripheral wall. The shallow angle of the slit allows the HTS tape to gradually transition from its anchored end secured within the ring's peripheral wall to engage the outer surface of the ring's peripheral wall.

It is thus a feature of at least one embodiment to provide a winding module that anchors an end of an HTS tape without sharply bending the tape while facilitating uniform winding in multiple layers that reduce bending stresses of the HTS tape and reduce instances of formation of inner waves and gaps between turns.

The winding modules may include electrical terminals that are incorporated into the inner ring. Each terminal may be an integral feature of the inner ring. This may include the terminal being a lobe-type extension of the inner ring's material, such as a feature formed by a common stamping or other cutout procedure that forms the inner ring. Each electrical terminal may extend inwardly from the ring's inner perimetral edge into a central ring body opening, which is surrounded by the inner ring. It is understood that the terminal's ring hole can be threaded to define a screw boss or can have threaded inserts to facilitate terminal connection. The terminal can be located on the center or anywhere inside the ring towards one side of the ring.

It is thus a feature of at least one embodiment to arrange the winding module's electrical terminal(s) internally or within a footprint defined by the coil of HTS material and avoid any protruding or overhanging electrical terminal structures to minimize exposure to potential hazards or damage and improve reliability.

Each winding module may include multiple winding arrangements, such as stacked winding arrangements. The stacked winding arrangements may include first and second (or more) winding arrangements vertically aligned and stacked with respect to each other, with adjacent coils of HTS material wound in opposite directions. Inner rings of the first and second winding arrangements may be mechanically aligned and connected, such as by registered mounting holes that receive fasteners to connect the inner rings to each other. A sheet of conductive material, such as a copper plate, may be arranged between the stacked winding arrangements.

It is thus a feature of at least one embodiment to provide stacking features that facilitate stacking multiple winding arrangements, include modular sets of winding arrangements, to create strong (er) magnets.

According to another aspect of the invention, an HTS winding design is provided for achieving quench-free operation in M W-scale motors with a large number of turns. This may include winding HTS tapes directly against a conductive inner ring without intervening insulation material between the inner ring and the HTS tape. The inner ring may serve as both a support structure and a current terminal. The inner ring is typically fabricated from a highly thermally and electrically conductive and structurally strong metallic material, such as copper. The central edge, inner wall, or inner perimeter of the inner ring may include a curved-lobe or circular-type connection point or electrical terminal. The terminal may be provided at ring's inner segment and be surrounded by a widened section to facilitate a half-slit winding starting point. The half-slit winding starting point is typically positioned adjacent to the terminal point or electrical terminal to minimize contact resistance, with the terminal point(s) located within the winding to protect it. Placement of the terminal point(s) provides a compact overall configuration of the winding module while avoiding overhanging HTS tapes that could be susceptible to physical damage. Placement of the terminal points can be anywhere inside the rings. In one example, the terminal points are shifted towards one side of the ring to make the connection on a side of the winding instead of on the center of the winding. The HTS tape is typically sandwiched between or covered by substrates, which may be conductive structures. All HTS turns of the HTS tape are typically covered between a conductive plate such as a copper plates and/or a winding holder attached to either side of the winding, which may include a precoated intervening insulative layer(s), which ensures no length of HTS tape(s) is exposed. It is understood that insulation may instead by implemented as a thin separative insulation layer such as a fiber cloth with resin. Such insulation layer may be arranged between single pancakes windings as well. The inner ring's perimeter wall may vary in width or include widened segments, which may be achieved with a curvature or slight angling of the ring's long (er) side segments that drifts outwardly from parallel lines projected from tangent points at outer surfaces of curvatures of the winding's end-turns. The widening of the ring's long (er) side segments may prevent interweaving associated with straight sections, which improves consistency in the winding. Both the inner ring and the HTS winding conform to this curvature or angling to maintain uniformity.

It is thus a feature of at least one embodiment of the invention to provide snugly nested wraps of winding material that reduce instances of unnecessary waviness in the winding's straight sections and relieve or reduce pressure on inner turns or layers despite an increased number of turns or layers compared to straight-line-type winding sections.

A thermal conductance plate or a winding holding plate may be provided by copper plate that is pre-coated with resin, an insulative layer/coating, or separate insulative layer installed on the winding. A resin applied to the HTS tape winding(s) adheres or attaches the copper plate to the winding, which reduces the likelihood of winding delamination. The conductive inner ring, HTS tape, copper plate, and a winding holder provide an overall compact form and large surface areas of engagement that are dimensionally stable and gap-free.

It is thus a feature of at least one embodiment to establish efficient thermal transfer paths that contribute to the winding's high thermal performance.

The winding is affixed to a winding holder, with the winding received in a cavity or groove of the holder. The winding holder has a tray-like body with through bore(s) through which fasteners extend to mount the holder and its winding to the rotor outer frame.

It is thus a feature of at least one embodiment to rigidly mount a winding in a holder that securely attaches to a rotor shall and against adjacent holders to provide a stable annular arrangement of field windings that resist Lorentz forces experienced during operation and ensure stability.

These particular objects and advantages may apply to only some embodiments falling within the claims and thus do not define the scope of the invention.

### BRIEF DESCRIPTION OF THE DRAWINGS

FIG. 1 is a simplified exploded view of the principal components of a superconducting motor constructed according to the present invention including a field winding system with winding holders supporting superconducting windings;

FIG. 2 is a perspective view of the superconducting field winding system of FIG. 1;

FIG. 3 is an exploded perspective view of a superconducting winding module;

FIG. 4 is a simplified exploded perspective view of a winding arrangement with its inner ring and coil;

FIG. 5 is an exploded perspective view of a winding arrangement with a top sheet layer;

FIG. 6 is an exploded view of a winding arrangement with a pancake configuration;

FIG. 7 is a perspective view of the assembled winding arrangement of FIG. 6;

FIG. 8 is an exploded perspective view of a variant of the winding arrangement of FIG. 6, with two sets of paired winding arrangement layers;

FIG. 9 is a perspective view of the assembled winding arrangement of FIG. 8; and

FIG. 10 is a cross-sectional view of the assembled winding arrangement of FIG. 8.

### DETAILED DESCRIPTION OF THE PREFERRED EMBODIMENT

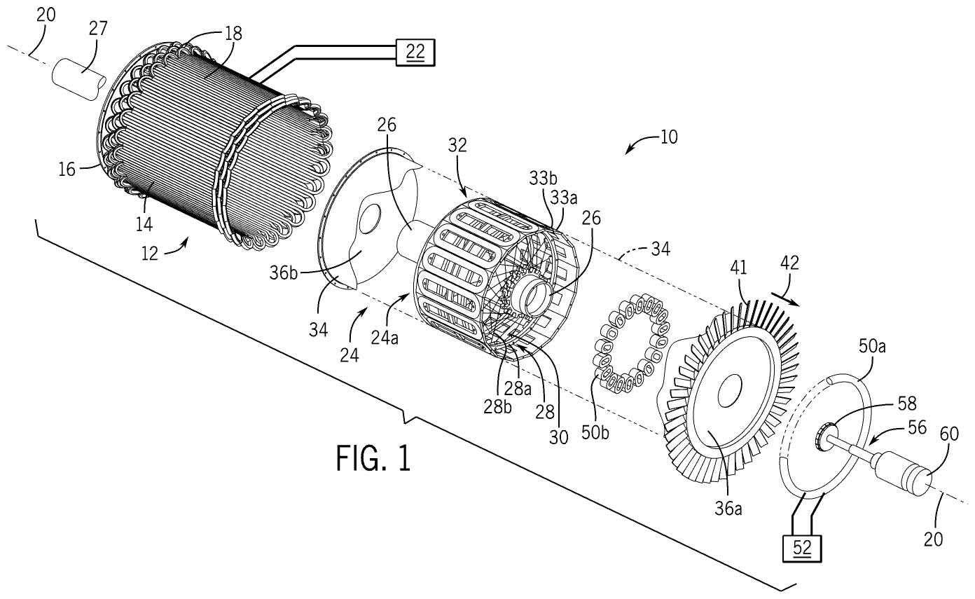

Referring now to FIG. 1, a superconducting motor 10 of the present invention is conduction-cooled and includes HTS (high-temperature superconducting) windings. Motor 10 may include a stator 12 providing, in one embodiment, a generally cylindrical, tubular stator form 14, shown having an outwardly flared end 16. A set of stator windings or coils 18 may be attached to an inner surface of the stator form 14 spaced angularly about an axis 20 of the stator form 14 and extending between its opposite ends in a race-track shape. The stator coils 18 may be air-core coils stabilized in a potting material as attached to the stator form 14 and may communicate with a motor drive circuit 22, for example, sequentially energizing the stator coils 18 to create a rotating magnetic field about the axis 20 as is generally understood in the art.

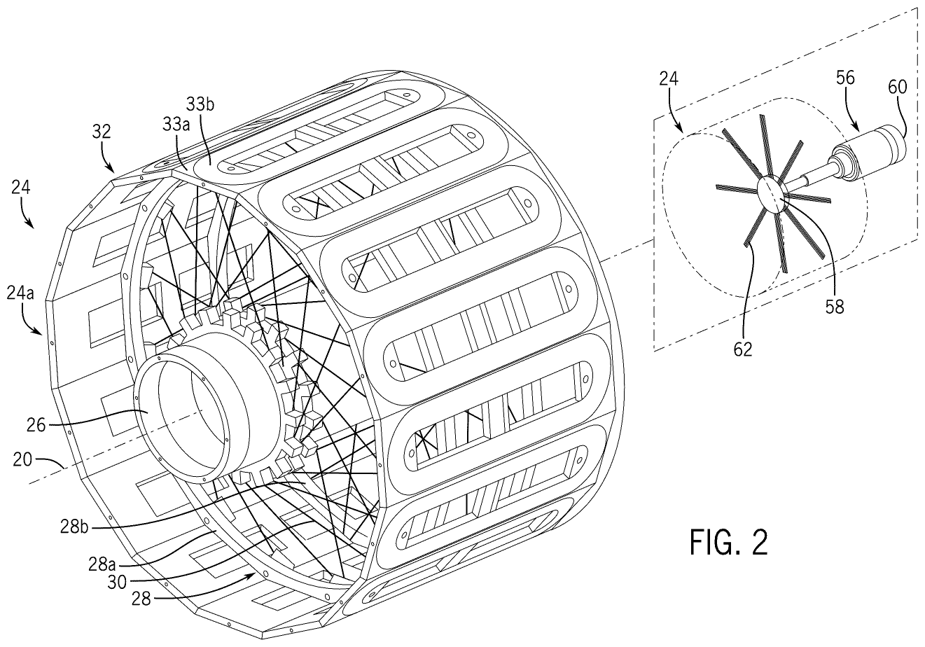

Referring also now to FIG. 2, fitting within the stator form 14 to rotate therein about the axis 20 is a rotor 24 providing a tubular rotor shaft 26 that may communicate beyond the confines of the motor 10 as a driveshaft connected, for example, to turbine or propeller systems of aircraft or the like (not shown). The tubular shaft 26 may be supported for rotation on bearings 29 (shown in FIG. 1) as are generally understood in the art.

Rotor 24 includes a field winding system arrangement or superconducting field winding system 24a that is supported by a rotor frame's outer frame segment, shown as outer frame 28. Field winding system 24a includes a set of winding modules 32 supported by rotor outer frame 28, which includes a pair of rims or hoops 28a, 28b that are positioned concentrically around the shaft 26. Hoops 28a, 28b and, correspondingly, outer frame 28 and winding modules 32 are held for co-rotation with the shaft 26 by a set of thermally insulated spokes 30 radiating outwardly from the shaft 26. In other implementations, the rotor outer frame 28 may be provided as a rotor shell that is a substantially cylindrical tube, for example, of aluminum or other lightweight material, to have low weight and low moment of inertia. Rotor outer frame 28 provides a mounting substrate for mounting the set of winding modules 32 that collectively define a concentric arrangement about the axis of shaft 26. Referring again to FIG. 1, stator coils 18 and winding modules 32 may be wirelessly monitored, for example, to detect quenching or imminent failure. Each winding module 32 may include a winding holder 33a that supports a superconducting winding 33b, typically defined by a coil of an HTS material.

Still referring to FIG. 1, in the illustrated implementation, a cylindrical vacuum envelope 34 closely surrounds the rotor 24 and includes end caps 36a and 36b providing bases to the cylinder and sealing the ends of the vacuum envelope 34 against the outer circumference of the shaft 26 to provide an airtight volume 38 that may be evacuated to reduce convective heat loss between the rotor 24 and outside structures of the motor and between the rotor 24 and the shaft 26. End cap 36b may have a radially outwardly extending impeller 41 pulling air, as indicated by airflow 42, over the outer surface of the stator form 14 for cooling of the same as the rotor 24 rotates. Positioned on either side of end cap 36a are wireless transmission coils 50a and 50b forming a primary and secondary windings of a transformer for transferring power through the vacuum envelope 34 without breach thereof to provide excitation power to the coils or windings of wind modules 32. Coil 50a may be energized by a high-frequency power source 52, and coil 50b may communicate with the windings 33b by means of a power conditioner 54 providing solid-state rectification and filtering of the alternating current transferred between the transmission coils 50a and 50b to produce the necessary DC voltages for the coils or windings 33b. Other systems for wirelessly providing current to the windings 33b include contactless flux pumps of a type known in the art.

Referring again to FIGS. 1 and 2, a cryocooler 56 may extend along the axis 20 and have a cold end 58 passing into the hollow tubular shaft 26 to be roughly centered within the ends of the rotor 24 and attached to the shaft 26 by insulating supports to rotate therewith. A hot end 60 of the cryocooler 56 may be extended outside of the vacuum envelope 34 and be fixed to a stationary structure so that rotation between the cold end 58 and hot end 60 may drive a sterling cycle heat pump pumping heat from the cold end 58 to the hot end 60 (at ambient temperatures) to bring the temperature of the cold end 58 to cryogenic temperatures of less than 50° Kelvin. Cryocoolers 56 suitable for use with the present invention are commercially available, for example, from the Sunpower Division of AMTEK of Berwyn, Pennsylvania, under the trade name CryoT el GT

Referring now to FIG. 2, thermally conductive straps 62 extend radially at equal angles about the cold end 58 to be thermally connected to axially-extending thermal leads attached to the inner surface of the rotor outer frame 28 and serving to draw heat from the winding modules 32 to the cold end 58. Generally, the conductive straps 62 pass through openings in the shaft 26 to be thermally insulated therefrom. The material of the conductive straps 62 may, for example, be a conductive metal such as copper and may be flexible to accommodate thermal contractions during cool down of the outer frame segment 28. Operation of the cryocooler 56 brings the winding modules 32 down to temperatures of less than 50° Kelvin suitable for providing superconductivity in winding modules 32, or temperatures of less than 77° Kelvin suitable for high temperature superconductivity.

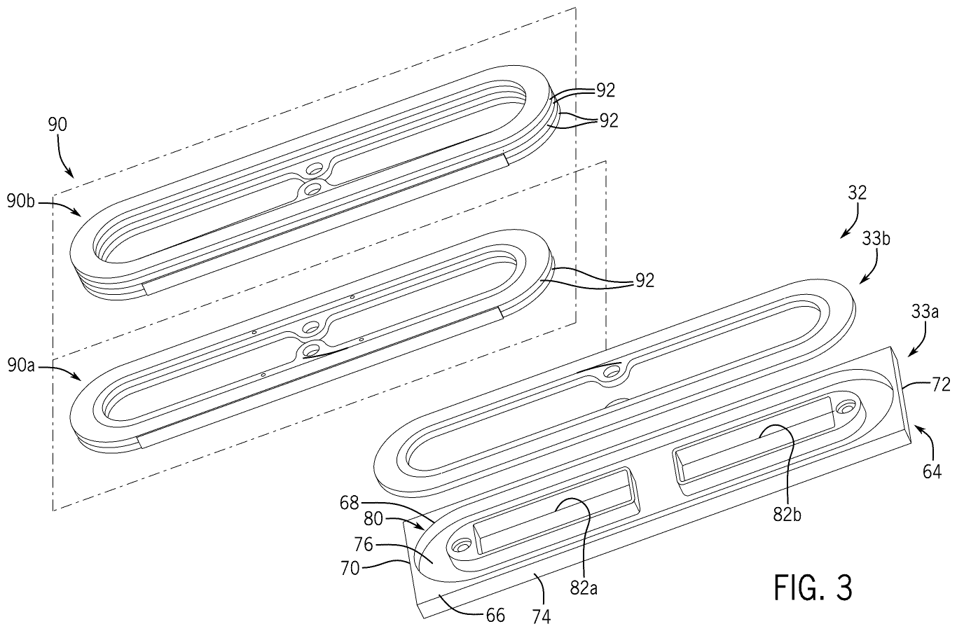

Referring now to FIG. 3, winding module's 32 winding holder 33a provides a tray-like rectangular body 64 that receives winding 33b. Winding holder body 64 has a pair of side walls 66, 68 that are interconnected by end walls 70, 72 and a bottom wall 74 and top wall 76. Chamber 80 is formed by a ring-shaped depression that extends into top wall 76. Two blocks 82a, 82b are arranged in chamber 80 and extend upwardly from bottom wall 74 and provide inner boundaries of chamber 80. Each block 82a, 82b includes interconnected walls that extend about a rectangular passage that presents an opening through bottom wall 74 and a screw-boss with a through-bore that receives a fastener to mount the winding block holder 64 to the remainder of the rotor 24, such as the rotor outer frame 28.

Still referring to FIG. 3, the shape of chamber's 80 depression corresponds to the exterior shape of winding 33b so the winding 33b fits snugly within the chamber 80. Winding 33b may be implemented with a multiple winding stacked feature(s), for example, as a multi-stacked winding assembly. Implementations of multi-stacked winding assemblies 90 are represented toward the upper-left corner of FIG. 3. Multi-stacked winding assembly 90a is shown with a pair of winding arrangements 92 that are vertically aligned and stacked with respect to each other. Multi-stacked winding assembly 90b is shown with two pairs or four vertically aligned and stacked winding arrangements 92.

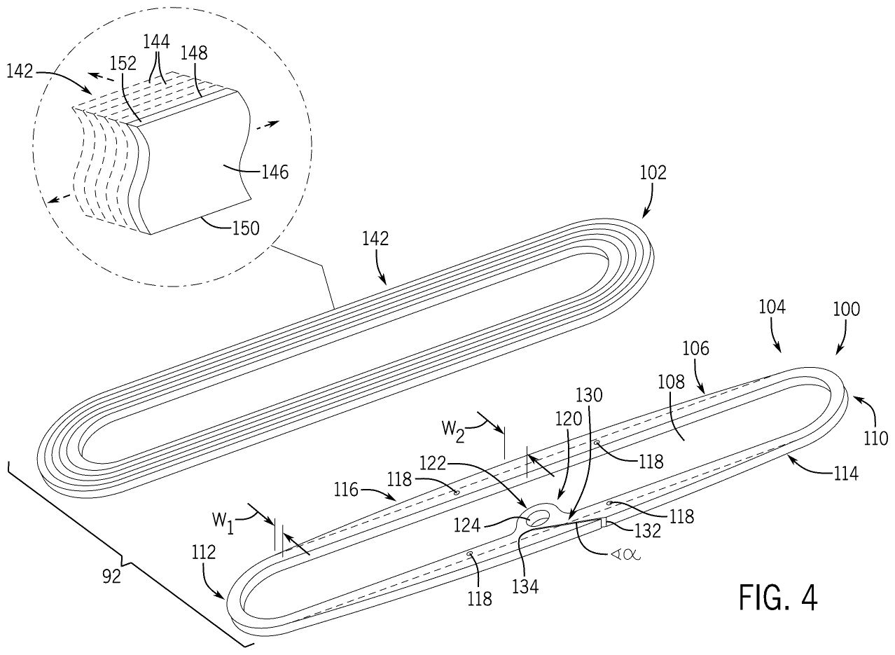

Referring now to FIG. 4, each winding arrangement 92 includes an inner ring 100 and a coil 102 of HTS material wrapped about inner ring 100. Inner ring 100 is supported by the winding holder 33a (FIG. 3) and defines a ring body 104 with a peripheral wall 106. Peripheral wall 106 provides a backer substrate against which the coil 102 of HTS material is wound and extends about a central ring body opening 108. Inner ring's 100 peripheral wall 106 defines an outwardly-facing outer perimeter and an inner perimeter that defines a boundary of the central ring body opening 108. The peripheral wall 106 has a width defined between its inner and outer perimeters, with the width typically varying as a function of its position upon the inner ring 100. Inner ring 100 may have a constant wall width along its curved end-segments 110, 112 and its wall-width may vary along the lengths of its elongate side segments 114, 116. Side segments 114, 116 are shown here with slightly arcuate or angled outer surfaces that correspond to widened sections or segments between the end segments 110, 112. From each end segment 110, 112, side segments 114, 116 increasingly widen toward their centers or middle portions along their lengths. As shown, at a first position near end segment 112, side segment 116 has a first width W1. At a second position at a middle portion of side segment 116, the side segment 116 has a second width W2 that is wider than W1, providing a widened segment. The dashed lines on the inner ring body 104 represent parallel paths to the inner perimeter, such that material outwardly of the dashed lines represent the widening of the peripheral wall 106.

Still referring to FIG. 4, inner ring 100 includes mounting holes or bores 118 that extend through the entire thickness of inner ring body 104. With background reference to FIG. 3, in multi-stacked winding assembly 90 implementations, respective mounting bores 118 of the stacked winding arrangements 92 align with each other to receive fasteners that connect the stacked inner rings 100 to each other to create the vertically stacked form.

Still referring to FIG. 4, inner ring 100 includes an electrical terminal 120 that provides an electrical conductive path to the superconducting winding 33b. Electrical terminal 120 is shown here as an arcuate lobe 122 that is an integral feature of inner ring 100 and projects inwardly, extending toward a centerline of inner ring 100. Lobe 122 may be formed by a common stamping or other cutout or forming procedure that forms the inner ring 100 and is arranged entirely within the central ring body opening 108. Bore 124 extends through lobe 122 and is configured to receive a fastener to electrically and mechanically connect the winding arrangement 92 and thus winding module 32 (FIG. 3) to other conductive rotor components.

Still referring to FIG. 4, shown at the widened portion of inner ring's 100 peripheral wall 106, slit 130 angularly extends from slit opening 132 at the wall's 106 outer surface or outer perimeter. Slit 130 defines a half-slit or partial slit that extends partially across the width of the peripheral wall 106 and terminates at slit bottom wall 134. The angle at which slit 130 extends is acute, shown as angle-α, as defined within a triangular or wedge-shaped web of material that radially overlaps material of the peripheral wall 106 on the other side of slit 130. Slit 130 is shown here arranged adjacent and outwardly of lobe 122, between the lobe 122 and outer surface of wall 106.

Still referring to FIG. 4, inner ring 100 is made from a highly electrically and thermally conductive material, such as copper, that provides electrical and thermal transmission paths between inner ring 100, including its terminal 120, and the coil 102 of HTS material which is anchored within inner ring 100 at an anchor joint 140. Anchor joint 140 is by slit 130 and an end of the length of coil's 102 HTS material that is received in slit 130. The HTS material is shown here as HTS tape 142 that is anchored in slit 130 at anchor joint 140 and is coiled or wrapped about inner ring 100 to provide the conductive winding of coil 102. HTS tape 142 typically has a flat cross-sectional profile and opposing major surfaces, such that each layer 144 of HTS tape 142 has inwardly and outwardly facing surfaces 146, 148 that extent between opposing edges 150, 152. HTS tape 142 is arranged on-edge with its inwardly facing surface 146 facing inner ring 100. HTS tape 142 is wrapped snuggly against inner ring 100, shown here wrapped with multiple wrap layers 144 with in full face-to-face engagement between respective inwardly and outwardly facing surfaces 146, 148 and with the inner-most layer's 144, inwardly facing surface 146 in full face-to-face engagement with the outer surface of inner ring 100. HTS tape 142 is typically a multi-layer web of material to provide the ribbon-like or tape-like form, whereby each layer 144 of HTS tape 142 is, itself, a multi-layered structure that includes various superconducting layers, substrate layers, and stabilization layers, as is known for HTS tapes. Materials of HTS tape 142 may include, for example, YBCO (yttrium barium copper oxide)-based, Hastelloy®-based, and/or others as substrates with suitable flexibility and other characteristics to allow snug winding about inner ring 100.

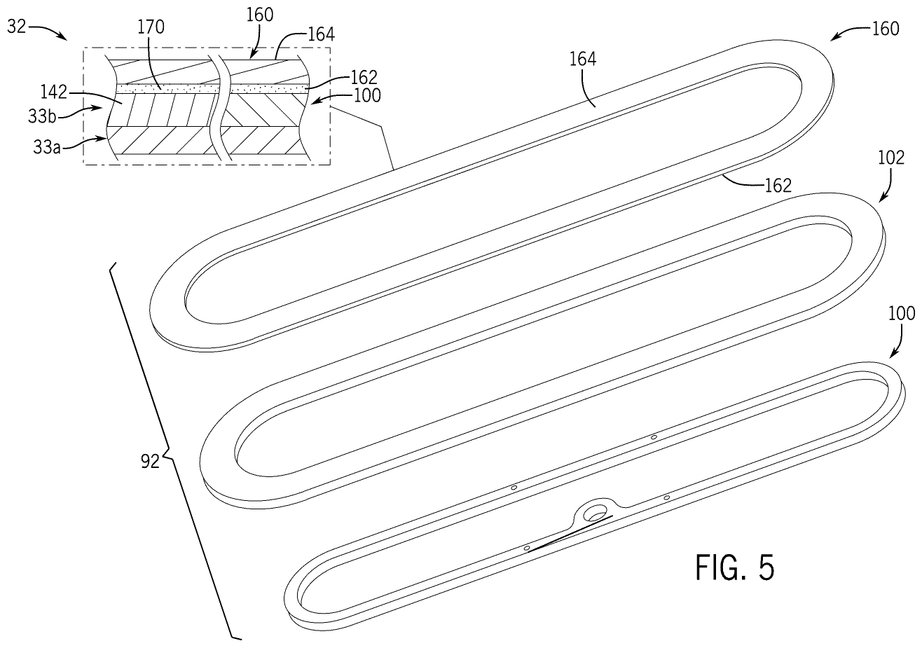

Referring now to FIG. 5, a thermal conductance plate or a winding holding plate may be defined by a sheet 160, which is typically made from a conductive material, such as copper and provides enhanced rigidity or structural reinforcement. Sheet 160 facilitates locking the upper edges of HTS tape 142 in fixed positions with respect to each other and holding HTS tape 142 surfaces in constant face-to-face engagement with each other. Sheet 160 has a perimeter shape that is generally racetrack shaped or ring-shaped as an elongate ovoid or rectangular with semicircular ends, along with a central opening, which substantially corresponds to the shape of the remainder of winding arrangement 92. Sheet 160 includes an underside or lower surface 162 that faces toward coil 102 and a topside or upper surface 164 that faces away from coil 102. Insulation layer 170 is pre-coated on the sheet lower surface 162 or inserted separately as an intervening layer between sheet 160 and HTS tape 142. Insulation layer 170 may be made from a material with high electrical insulative characteristics and high thermal conductivity, such as boron nitride, to both electrically insulate and promote heat transfer through the layers of the winding arrangement 92. Insulation layer can only cover the edges of the sheet and winding in some cases and can be used together mechanical reinforcement layer such as Stycast combined with fiberglass fiber layer.

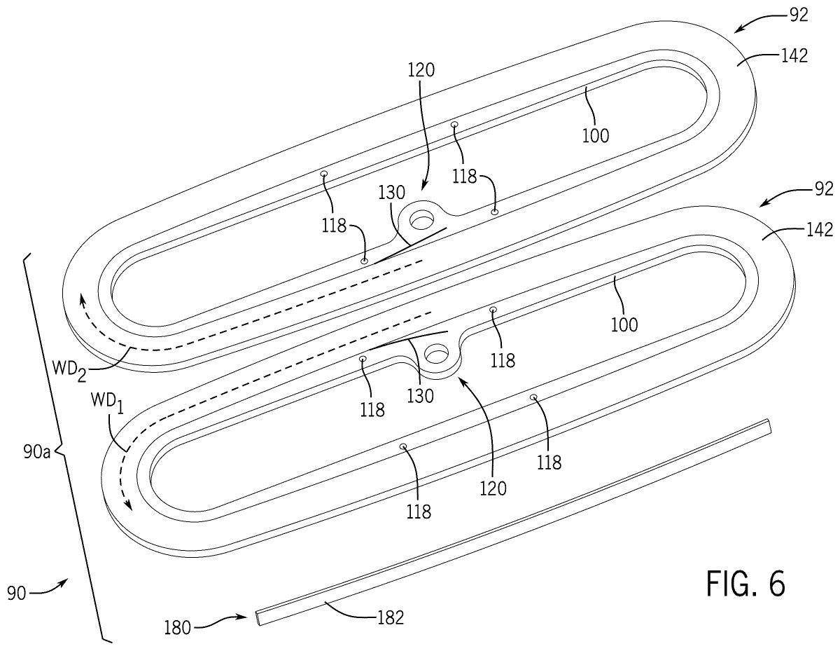

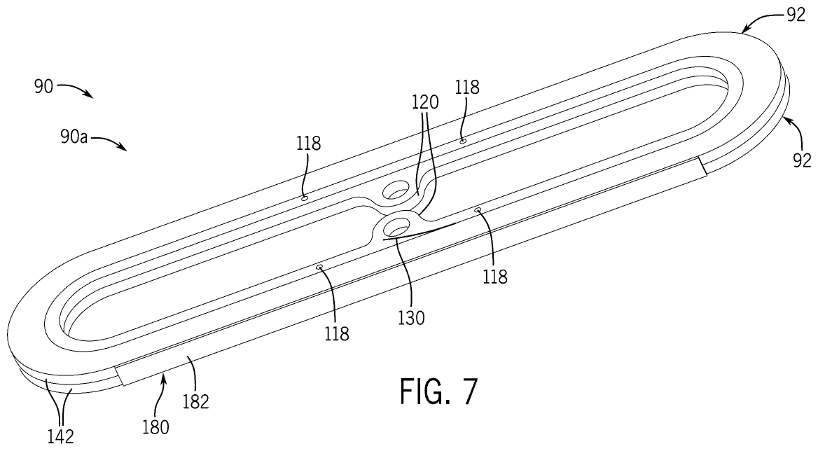

Referring now to FIGS. 6-7, multi-stacked winding assembly 90 is shown here as winding assembly 90a with a pair of vertically aligned and stacked winding arrangements 92, or a double pancake winding configuration. In the double pancake configuration of winding assembly 90a, the HTS tapes 142 of the upper and lower winding arrangements 92 are wound in opposite directions. This is represented by the dashed arrows as first and second opposite winding directions WD 1, WD 2 to ensure consistent current flow direction through the winding assembly 90. A coil joint 180 is provided at an interconnection between the HTS tapes 142 of the stacked winding arrangements 92. Coil joint 180 includes HTS joint tape 182, which is a length of HTS tape that is typically the same as HTS tape 142 only wider to span between and engage both of the two vertically stacked layers of HTS tape 142. Accordingly, HTS tape 142 of one of the winding arrangements 92 is wound clockwise, HTS tape 142 of the other winding arrangement 92 is would counterclockwise, and HTS joint tape 182 spans across and engages both HTS tapes 142 to maintain consistent current direction across all stacks, resulting in stronger magnetic fields upon stacking. As shown in FIG. 7, the width (or height) of HTS joint tape 182 is approximately twice that as each of HTS tapes 142 so that HTS joint tape 182 covers substantially all of the combined width (or height) of both HTS tapes 142. Although shown at the outer surfaces of the long (er) winding arrangements 92, it is understood that coil joint 180 may be arranged at other segments of the winding arrangements 92, such as at the turns or curved ends and/or inner surfaces. In the assemblage of the double pancake winding or other multi-stacked winding assembly 90, the windings, coils, or winding arrangements 92 are typically bonded with a cryogenic resin such as Stycast® and typically with a copper layer such as plate or sheet 160 (FIG. 5).

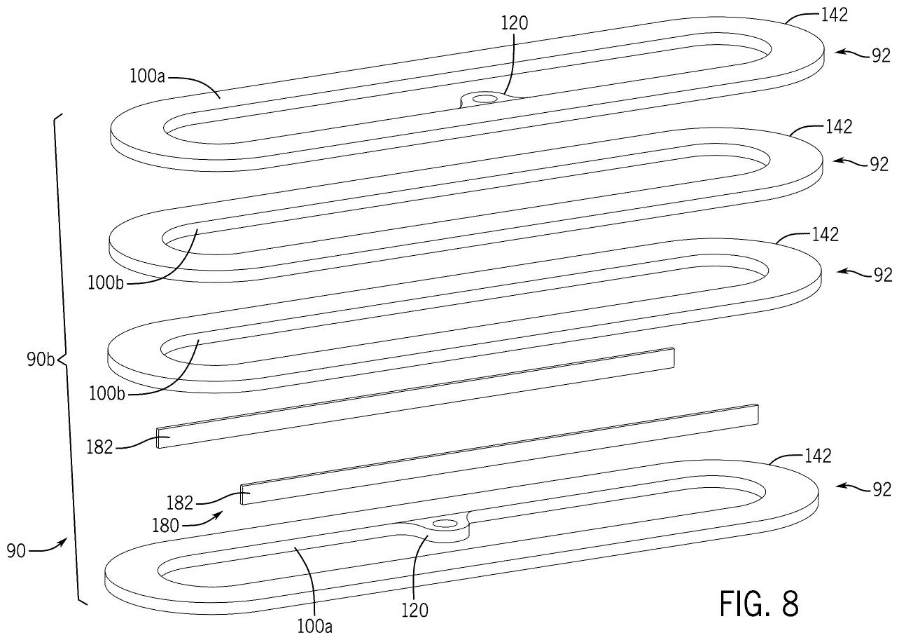

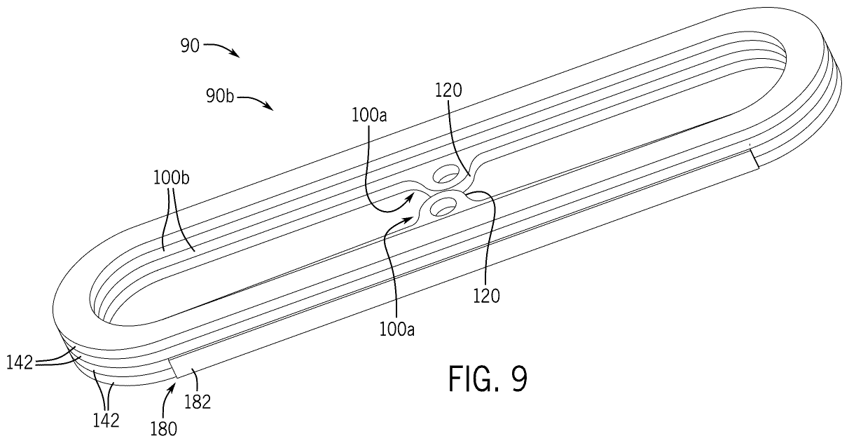

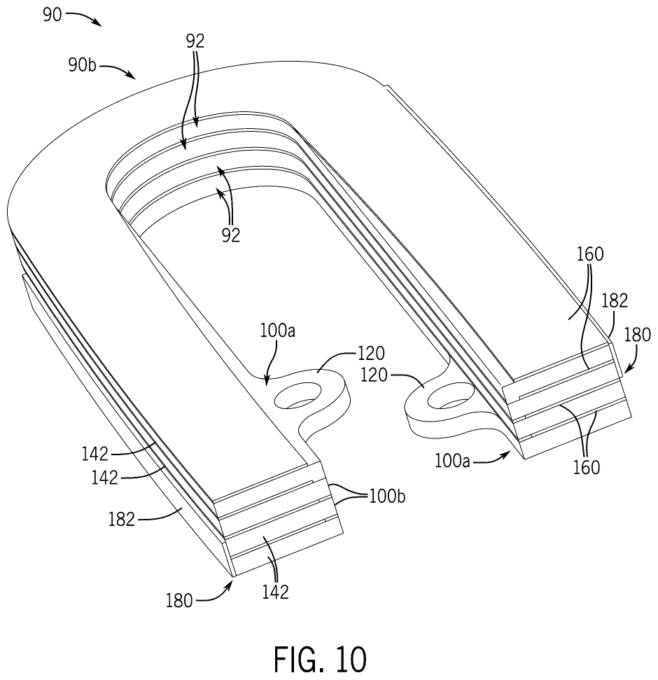

Referring now to FIGS. 8-10, multi-stacked winding assembly 90 is shown here as multi-stacked winding assembly 90b with two pairs of vertically aligned and stacked winding arrangements 92, or two sets of double pancake windings. Such modularity of stackable winding arrangements 92 may be repeated, as desired, to achieve the overall target number of stacked layers. Accordingly, the description of multi-stacked winding assembly 90 of FIGS. 6-7 is applicable here with respect to FIGS. 8-10. The difference is that the multi-stacked winding assembly 90b of FIGS. 8-10 is generally doubled in the vertical stack direction compared to that of winding assembly 90a. Furthermore, multi-stacked winding assembly 90b is shown with two pairs of double pancake coils or four layers of winding arrangements 92 and two electrical terminals 120. In multi-stacked winding assembly 90b, each pair of stacked winding arrangements 92 include a first inner ring 100a with an electrical terminal 120 and a second inner ring 100b that does not have an electrical terminal 120. Typically, inner rings 100a, 100b are the same except for inner ring 100a including the electrical terminal 120. As shown in FIG. 10, in this implementation, the inner-most and outer-most winding arrangements 92 include inner rings 100a with electrical terminals 120 and the two intermediate or middle winding arrangements 92 include inner rings 100b without electrical terminals 120.

Referring generally to FIGS. 3-10, to make the winding modules 32, each superconducting winding 33a is made and then secured into the winding holder 33b. An anchor end or end of the length of HTS tape 142 is inserted into slit 130 and soldered to the copper inner ring 100. The length of HTS tape 142 is wound onto the inner ring 100 to create a generally race-track shaped winding or coil 10. An insulation layer 170 is applied to the copper plate or sheet 160, which is attached to the HTS tape 142. The insulation 170 is precoated onto sheet 160, which is then affixed to the HTS tape 142 winding before curing of a resin or while the resin remains wet, typically a cryogenic resin such as Stycast®. In double pancake configurations, the slit 130 angular directions of inner rings 100 are arranged opposite each other so the HTS tapes 142 of the two inner rings 100 are wound in opposite directions. Coil joints 180 (FIGS. 6-10) are formed by securing a wide (er) HTS joint tape 182 to span across and interconnect HTS tapes 142 of the different stacked winding arrangements 92 to maintain consistent current direction. In the stacked arrangement, cryogenic resin is used as a bonding agent to attach the stacked winding arrangements 92 as well as intervening copper plates or sheets 160, typically with a sheet 160 positioned between each winding stack 92 adjacent another or covering an otherwise exposed winding stack 92. The winding stacks 92 are further mechanically secured to each other with fasteners that extend through aligned mounting bores 118 (FIGS. 6-7) of inner rings 100. In a four-winding or two-set double pancake implementation, the middle inner rings 100b (FIGS. 8-10) are positioned toward the middle of the stack. Placement of coil joint(s) 180 may include alternating positions of HTS joint tape 182, such as inward and outward, and repeated as a function of the number of levels in the stacked arrangement. Regardless of the particular number of levels or layers, typically all electrical terminals 120 are fully arranged within central ring body opening 108 or entirely inside a projected footprint of the winding assembly 90. The assembled winding 33a is placed in the groove or chamber 80 of winding holder 33b. The assembled winding 33a and winding holder 33b are subjected to vacuum impregnation with cryogenic resin and allowed to cure to form the entire assemblage of winding module 32. Each winding module 32 is installed onto the rotor out frame 28 (FIGS. 1-2), with adjacent modules 32 abutting each other to providing the continuous field winding system 24a.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties

To aid the Patent Office and any readers of any patent issued on this application in interpreting the claims appended hereto, applicants wish to note that they do not intend any of the appended claims or claim elements to invoke 35 U.S.C. 112 (f) unless the words “means for” or “step for” are explicitly used in the particular claim.

What we claim is:

1. A superconducting electric motor comprising:
a stator; and
a rotor having a central shaft rotatably mounted with respect to the stator to allow the rotor to rotate about a shaft axis with respect to the stator, wherein the rotor includes:
a superconducting field winding system that includes:
a rotor outer frame suspended about the shaft
a set of winding modules providing a concentric arrangement about the shaft axis with each winding module including:
a winding holder supported by the rotor outer frame; and
a superconducting winding defined by a coil of an HTS (high-temperature superconducting) material and attached to the winding holder.

2. The superconducting electric motor of claim 1 wherein the set of winding modules collectively defines a continuous outer periphery of the field winding system.

3. The superconducting electric motor of claim 1 wherein adjacent winding holders of the adjacent winding modules abut each other at respective side edges to define the continuous outer periphery of the field winding system.

4. The superconducting electric motor of claim 1 wherein each winding module further comprises an inner ring that:
is supported by the winding holder; and
defines a ring body with a peripheral wall that extends about a central ring body opening.

5. The superconducting electric motor of claim 1 wherein:
the superconducting winding includes a length of the HTS material defined between an inner end of the length of HTS material and an outer end of the length of HTS material;
the inner end of the length of HTS material extends into the ring body peripheral wall to define an anchor joint between the length of HTS material and the ring body peripheral wall at a winding initiation location.

6. The superconducting electric motor of claim 5 wherein:
the length of HTS material is defined by an HTS tape with a flat cross-sectional profile and opposing major surfaces including an inwardly facing surface and an outwardly facing surface that extend between opposing edges;
the HTS tape is arranged on-edge with the inwardly facing surface facing the inner ring, the HTS tape wrapped about the inner ring and itself to provide multiple wrap layers as the coil of HTS material; and
the anchor joint is defined by:
a slit that extends into the ring body peripheral wall; and
the inner end of the HTS tape.

7. The superconducting electric motor of claim 6 wherein:
the ring body peripheral wall defines:
an outer perimeter distal the central ring body opening;
an inner perimeter proximate the central ring body opening; and
a width defined between the outer and inner perimeters;
the slit extends from the outer perimeter of the ring body peripheral wall partially across the width of the ring body peripheral wall toward the outer perimeter of the ring body peripheral wall.

8. The superconducting electric motor of claim 5 wherein:
the slit extends at an acute angle with respect to the outer perimeter of the ring body peripheral wall.

9. The superconducting electric motor of claim 8 wherein:
the width of the ring body peripheral wall varies along its periphery and includes at least one widened segment;
the slit is arranged at the at least one widened segment of the ring body peripheral wall.

10. The superconducting electric motor of claim 4 wherein:
the inner ring:
is made from an electrically conductive material; and
includes an electrical terminal providing an electrical conductive path to the superconducting winding.

11. The superconducting electric motor of claim 10 wherein the electrical terminal extends as a protrusion into the central ring body opening.

12. The superconducting electric motor of claim 11 wherein the electrical terminal is defined by a lobe of the inner ring electrically conductive material that extends inwardly toward a centerline of the winding module.

13. The superconducting electric motor of claim 10 wherein:
the electrical terminal is a first electrical terminal extending into the central ring body opening in a first direction from a first portion of the inner ring; and
a second electrical terminal extends as a protrusion into the central ring body opening in a second direction opposite the first direction from a second portion of the inner ring.

14. The superconducting electric motor of claim 4 wherein each winding module defines a multi-stacked winding assembly that includes:
a first winding arrangement that includes a first inner ring concentrically inwardly supporting a first coil of HTS material; and
a second winding arrangement that includes a second inner ring concentrically inwardly supporting a second coil of HTS material.

15. The superconducting electric motor of claim 14 wherein:
at each winding module the first and second winding arrangements:
are vertically aligned and stacked with respect to each other;
include corresponding first and second coils of HTS material; and
the first and second coils of HTS material are wound in opposite directions with respect to each other.

16. The superconducting electric motor of claim 14 wherein:
the of HTS material of each of the first and second coils is defined by a respective first and second length of an HTS tape material; and
the first and second coils are defined by flat wound spirals of the HTS tape material to define first and second pancake windings;
the first and second pancake windings are stacked to define a stacked pancake winding arrangement of the multi-stacked winding assembly; and
the winding module further includes:
a pair of electrical terminals that extend radially inward into the central ring body opening.
